(19) United States
(12) Patent Application Publication
(10) Pub. No.: US 2005/0264494 A1
(43) Pub. Date: Dec. 1, 2005

(54) Bistable electoluminescent panel with three electrode arrays

(76) Inventors: Christophe Fery, Rennes (FR); Jean-Paul Dagois, Cesson Sevigne (FR)

Correspondence Address: THOMSON LICENSING INC., PATENT OPERATIONS, PO BOX 5312, PRINCETON, NJ, 08543-5312, US

(21) Appl. No.: 11/108,416

(22) Filed: Apr. 18, 2005

(30) Foreign Application Priority Data
Apr. 16, 2004 (FR) 0404037

(51) Int. Cl. G09G 3/30

(52) U.S. Cl. 345/76

(57) ABSTRACT

A bistable electroluminescent panel, in particular based on photoconductive effect, with only three electrode arrays in total is described.

### FIELD OF THE INVENTION

The invention relates to a bistable electroluminescent panel for displaying images.

### BACKGROUND OF THE INVENTION

Active matrix electroluminescent panels comprising an array of electroluminescent cells disposed on an array of pixel control circuits etched in a semiconductor substrate, for example based on polycrystalline silicon, are known. Each pixel circuit normally comprises, to control the associated cell, a current modulator in series with that cell. The terminals of this series are each linked to a power supply electrode of each array. The pixel circuit is also provided with a scanning electrode intended to activate this circuit, and a data electrode linked to the setpoint of the current modulator and intended for addressing video data to the cell. Thus, for each pixel, there are four electrodes: two power supply electrodes, one scanning electrode and one data electrode. These panels therefore normally comprise at least four electrode arrays.

Also known are “bistable” electroluminescent panels, with passive matrix, in which each pixel comprises an electroluminescent cell and a bistable element in series. This series is connected between two electrodes which are used both for driving and power supply purposes, as, for example, described in documents WO 03/012869 and WO 03/054843. These panels are therefore provided with only two electrode arrays.

Depending on the voltage signal applied to each series, the bistable element of each panel can be switched from a stable high impedance “off” state to a stable low impedance “on” state in response to a selective activation voltage addressing signal, or vice versa in response to an erase voltage addressing signal, and can be maintained in the off or on state in which it has been set by this addressing signal, by applying a “sustain” voltage which is the same for all the cells of the panel.

documents U.S. Pat. Nos. 4,035,774; 4,808,880; 6,188,175 B1; 5,055,739 as well as WO 03/012869 and WO 03/054843 describe panels of this type, in which each pixel comprises an organic electroluminescent layer and a stacked photoconductive layer. The photoconductive layer forms the bistable element of the pixel.

Other bistable elements can be envisaged such as n-p-n-p junctions as described, for example, in documents FR 2846794 or such organic layers as described for example, in document US 2002-190664.

Document US 2002-0043927 descriebs a photoconductive effect-based bistable electroluminescent panel, in which the switching of the photoconductive bistable elements is generated by the emission of electroluminescent cells specifically dedicated to addressing, disposed on the back of the panel (57). Each addressing electroluminescent cell is optically coupled, via an insulating layer (44), with a bistable element of the photoconductive layer (51). Thus, each addressing electroluminescent cell controls the ON or OFF state of each pixel of the panel. There are therefore four electrode arrays: two arrays for powering the addressing electroluminescent cells and two arrays for powering the main electroluminescent cells.

Document JP 11-154597 also describes a photoconductive effect-based bistable electroluminescent panel provided with four electrode arrays. With reference to FIGS. 4 and 5 of this document, at each pixel, the electroluminescent layer (20) is subdivided into an area intended for addressing between two addressing electrodes 17, 24 intersecting in this addressing area and a main emission area in series with a photoconductive element 14, this series being powered between two power supply electrodes 12, 22 intersecting in this main emission area. The photoconductive element 14 is disposed close to the electroluminescent area intended for addressing, to obtain an optical coupling. As for document US 2002-0043927, there are therefore two arrays of addressing electrodes and two arrays of power supply electrodes.

The problem with photoconductive effect-based bistable electroluminescent panels with two electrode arrays as described in the abovementioned documents WO 03/012869 and WO 03/054843 is that the capacitive losses in the pixel addressing sequences are very high.

In practice, if the vertical electrodes of one of the arrays are called columns and the horizontal electrodes of the other array are called rows, the capacitive loss for a column can be expressed as: E=C·Va²·N·f·s, in which C is the capacitance between electrodes at an intersection of a row and a column, N is the number of rows, Va is the addressing voltage, f is the frame frequency and s is the number of subframes in each frame. Since the electrodes are also used for power supply purposes, they present a surface area that is big enough to transfer to the cells the electrical power supply with no loss of charge, and the capacitance C is therefore high, which causes high capacitive losses.

The problem with photoconductive effect-based bistable electroluminescent panels with four electrode arrays as described in the abovementioned documents US 2002-0043927 and JP 11-145597 is their complexity associated, in particular, with the number of electrode arrays, the complexity being economically disadvantageous.

Document EP 1246157 describes an active matrix electroluminescent panel. Each cell has a corresponding pixel circuit which is incorporated in the active matrix which comprises a bistable element (“memory” element 10) linked in series with an electroluminescent cell (8) and control means represented by a transistor (3). This panel has four electrode arrays: two arrays used only for powering the cells (6, 7), one array (4) used to control the control means (3) and one array used for addressing (5). Three of these four arrays must be incorporated in the active matrix. The need, in this case, to incorporate three electrode arrays in the active matrix is economically disadvantageous, even in terms of light performance of the panel.

### SUMMARY OF THE INVENTION

One object of the invention is to avoid the abovementioned problems by proposing bistable electroluminescent panels, in particular based on photoconductive effect, with only three electrode arrays in total.

To this end, the object of the invention is to produce a bistable electroluminescent panel for displaying images comprising, disposed on a substrate an array of electroluminescent cells C_{n,p} and an array of bistable elements B_{n.p}, each associated with a cell and provided with control means, a first array of electrodes used for power supply Xₚ and a second array of electrodes Yₙ used for power supply, in which each electroluminescent cell C_{n.p} is linked in series with the bistable element B_{n,p} which is associated with it between an electrode Xₚ of the first power supply array and an electrode Yₙ of the second power supply array, characterized in that it comprises, to the exclusion of any other array of electrodes linked to the cells, an array of electrodes used mainly for addressing Aₚ, and in that the means of controlling the bistable element of each electroluminescent cell C_{n,p} are linked between an electrode Aₚ of the array used mainly for addressing and a power supply electrode Yₙ of said cell belonging to the second array, which is thus used both for addressing and for power supply.

According to the invention, the same electrode is used both to control the bistable element control means and to power the electroluminescent sells corresponding to these elements. By applying, for example, the invention to the panel described in FIG. 1 in the abovementioned document EP 1246157, the scanning electrode 4, which controls the control means represented by the transistor 3, and the power supply electrode 6 form only one and the same electrode. The number of electrode arrays of the panel is thus advantageously limited compared to the four arrays described in that document.

Another object of the invention is to produce a bistable electroluminescent panel for displaying images comprising, disposed on a substrate an array of electroluminescent cells C_{n,p} and an array of bistable elements B_{n.p}, each associated with a cell and provided with control means, an array of electrodes used only for power supply Xₚ, and an array of electrodes Yₙ used both for addressing and for power supply and extending transversally to the electrodes of the other array Xₚ, in which each electroluminescent cell C_{n,p} is linked in series with the bistable element B_{n.p} that is associated with it between and electrode Xₚ of one of the power supply arrays and an electrode Yₚ of the other power supply array, characterized in that it comprises, to the exclusion of any other array of electrodes linked the cells, an array of electrodes used mainly for addressing Aₚ and extending approximately parallel to the electrodes used only for power supply Xₚ, and in that the means of controlling the bistable element of the electroluminescent cell C_{n,p} are linked between an electrode Aₚ of the array used mainly for addressing and the power supply electrode Yₚ of said cell, which is thus used both for addressing and for power supply.

Preferably, the electrode Aₚ of the array used mainly for addressing are narrower than the electrodes Xₚ of the first power supply array. The capacitive losses in the addressing phases of the panel are thus limited without increasing the charge losses on the cell power supply circuit.

Preferably, these addressing electrodes are at least two times narrower than the power supply electrodes, which means that the capacitive losses are more significantly limited.

Preferably, each electroluminescent cell C_{n,p} is linked in series with the bistable element B_{n.p} which is associated with it using an electrode forming an intermediate layer. The intermediate electrodes of the various cells are electrically insulated from each other. They are normally floating.

Preferably, said intermediate electrode is transparent or semi-transparent and the bistable element associated with this cell comprises a photoconductive layer which is inserted between said intermediate layer and the electrode Xₚ used only for powering said cell. Thus, each pixel of the panel comprises an electroluminescent layer element and a photoconductive layer element with an intermediate electrode between these two layer elements. Because of the transparency of the intermediate electrode, immediately the bistable element is switched to the on state using the control means of this element, the electroluminescent layer element emits light which, through the transparent intermediate electrode, maintains the low impedance state and therefore the on state of the photoconductive layer element.

Preferebaly, for each electroluminescent cell C_{n,p}, the means of controlling the associated bistable element comprise an addressing electroluminescent layer which is inserted between the electrode Aₚ used mainly for addressing said cell and the electrode Yₙ used both for addressing and for power supply, and which is optically coupled with the photoconductive layer of said bistable element.

Preferably, each electroluminescent cell C_{n,p} comprises a main electroluminescent layer which forms one and the same layer with the electroluminescent layer addressing the control means of the bistable element of said cell. The optical coupling between the electroluminescent layer and the photoconductive layer is then provided through the transparent or semi-transparent intermediate electrode.

Preferably, all the electrodes Xₚ used only for power supply are interlinked at the same potential.

Another object of the invention is to produce an image display device comprising a panel according to the invention.

### BRIEF DESCRIPTION OF THE DRAWINGS

The invention will be better understood from reading the description that follows, given by way of nonlimiting example, and with reference to the appended figures, in which:

FIG. 1 is a diagrammatic plan view of a panel according to an embodiment of the invention, which illustrates the three electrode arrays specific to the invention,

FIG. 2 is a cross-sectional view through AA′ of FIG. 1 of a pixel of the panel of FIG. 1,

FIG. 3 is a variant of the structure of FIG. 2, which corresponds to a second embodiment of the invention, and

FIG. 4 represents timing diagrams of voltage signals applied to drive the panel according to the embodiment of FIG. 1.

The figures representing timing diagrams do not take into account the scale of values in order to better represent certain details that would not be clearly apparent if the proportions were respected.

To simplify the description, identical or similar references are used for elements that provide the same functions.

### DETAILED DESCRIPTION

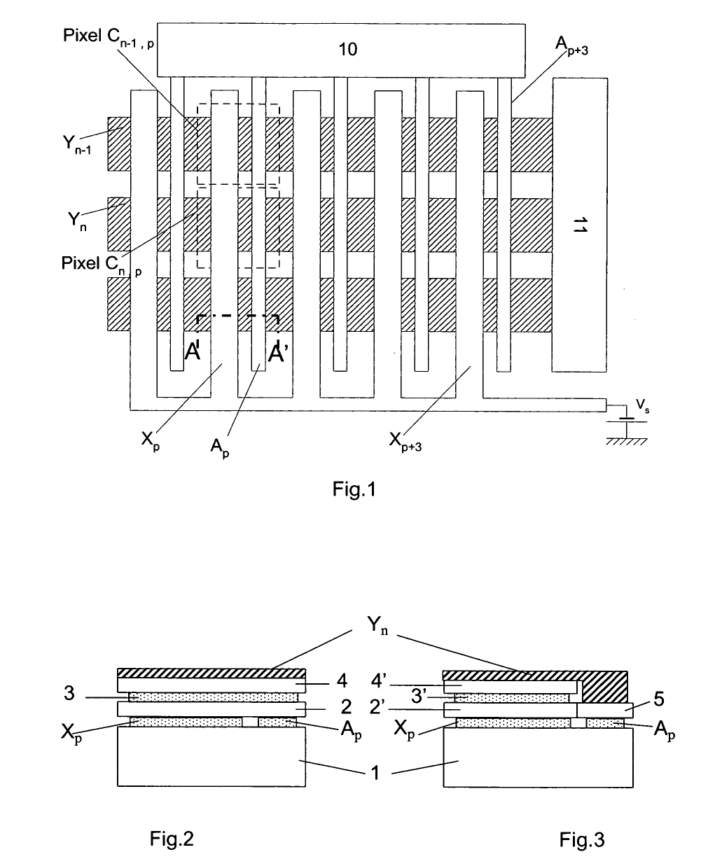

Referring to FIGS. 1 and 2, the panel according to the invention comprises a substrate 1 which directly supports two arrays of electrodes, the first power supply array Xₚ intended to be used only to power the cells, and an array Aₚ intended to be used mainly for addressing. The electrodes of these two arrays are parallel, extending vertically and are therefore named “columns”. The power supply electrodes Xₚ are substantially wider than the addressing electrodes Aₚ, preferably at least twice as wide. Between two adjacent addressing electrodes, there is a power supply electrode Xₚ, and vice versa. According to a variant that is not represented, each power supply electrode Xₚ is subdivided into two electrodes Xₚₐ, X_{pb} and each addressing electrode Aₚ is positioned between two subdivided electrodes Xₚₐ, X_{pb}.

These two electrode arrays directly support a photoconductive layer 2, which itself supports transparent intermediate electrodes 3, which in turn support an organic electroluminescent layer 4, which itself supports the second power supply array Yₙ, the electrodes of which extend perpendicularly to the electrodes Xₚ and Aₚ of the other arrays. These electrodes Yₙ are used both for addressing and for power supply.

At each intersection of an electrode Xₚ and an adjacent electrode Aₚ with an electrode Yₙ there is an electroluminescent cell C_{n,p} of the panel, a cross section of which is represented in FIG. 2. This electroluminescent cell comprises a portion of organic electroluminescent layer 4. The portion of the photoconductive layer 2 situated under this portion of organic electroluminescent layer 4 forms a bistable element B_{n.p} associated with this cell. The series formed by the electroluminescent cell C_{n,p} and this bistable element B_{n.p} is linked between the electrode Xₚ and the electrode Yₙ at the intersection of which this cell is located. The intermediate electrodes 3 of the various pixels of the panel are electrically insulated from each other. These electrodes are floating.

At the intersection of the electrode Aₚ adjacent to the electrode Xₚ with the same electrode Yₙ are located the control means of the bistable element B_{n.p}. These control means are here formed by the same electroluminescent 4 and photoconductive 2 layers with, inserted between them, the intermediate electrode 3. A variant concerning these control means will be described later.

Since the intermediate electrodes are transparent, there is an optical coupling between the control means and the bistable elements. When the portion of electroluminescent layer located at the intersection of the electrode Aₚ with the electrode Yₙ produces light following the application of an appropriate addressing voltage signal between these electrodes, this produced light passes through the transparent electrode 3 to the photoconductive layer 2 which then switches to a low impedance state, thus causing the state of the bistable element B_{n.p} to switch over. The power supply voltage applied between the electrodes Xₚ and Yₙ is then relayed to the terminals of the cell C_{n,p} which then emits the light.

The fabrication of the panel according to the invention that has just been described will not be given here in detail. It involves means and methods that are intrinsically known.

There now follows a description of a disply device provided with such a panel and, by way of nonlimiting example, a method of driving the panel.

With reference to FIG. 1, this device therefore comprises the panel which has just been described, means 10 of controlling the addressing electrodes Aₚ, means 11 of controlling the row electrodes Yₙ, used both for addressing and for power supply. These control means 10 and 11, called “driver”, are designed to send to the electrodes power supply voltage, select or addressing signals which will be described later and which are generated by means that are not represented.

With reference to FIG. 1, all the electrodes Xₚ of the array used only for power supply are linked to each other and to the means of powering the panel which deliver the same power supply voltage Vₛ to these electrodes.

To drive the panel so as to display a succession of image frames, each frame being broken down into subframes according to the number of bits required to encode the grey scales of the images, the procedure is as follows: for the duration of each subframe, using means 11 of controlling the row electrodes Yₙ, each row electrode Yₙ of the panel is selected in turn.

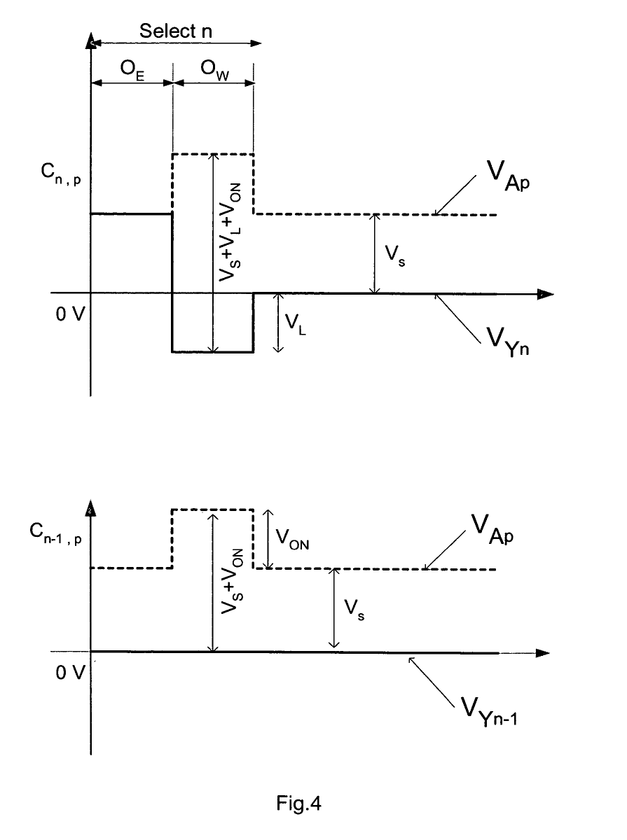

As represented at the top of FIG. 4, the selection of each row n comprises two operations. Firstly, an erase operation O_{E} designed to switch to the high impedance OFF state all the bistable elements of the cells C_{n,p} of this row without the state of the bistable elements of the cells of the other rows being affected. Then, a write operation O_{W}, designed to switch to the low impedance ON state the bistable elements of the cells C_{n,p} of this row which must be activated to display the image of the current subframe, and maintain the OFF state of the bistable elements of the other cells of this row which are not to be activated to display the image of the current subframe, again without the state of the bistable elements of the cells of the other rows being affected.

FIG. 4 represents the timing diagrams of the voltage signals applied for addressing one of the cells C_{n,p} of a row n. For the erase operation the same voltage Vₛ equal to the common voltage applied to the power supply columns Xₚ is applied to the row n and to all the addressing electrodes Aₚ. The voltage applied to the other rows, including the row n-1, is maintained at 0 V. All the cells of the row n are then off and the cells of the other rows continue to be powered by the potential difference Vₛ between the power supply electrodes Xₚ at the potential Vₛ and the row electrodes such as Yₙ₋₁ at the potential 0 V. During the write operation, a negative amplitude voltage V_{L} is applied to the selected rown. To activate a cell C_{n,p} of this row, a voltage Vₛ+V_{ON} is applied to the addressing electrode Aₚ which corresponds to it. So as not to activate a cell C_{n,p} of this row, the addressing electrode Aₚ which corresponds to it is maintained at the potential of the preceding operation Vₛ (not represented).

This row n selection phase is followed by other row selection phases, and normally a general maintenance phase during which, still during the same image subframe, the voltage applied to the row n is maintained at the level 0 V. Because of this, the potential difference between the electrodes powering the pixels of this row is then sustained at the value Vₛ so as to power the activated cells of this row for the duration of the image subframe.

All of these voltage signals are applied in a manner known per se using the control means 10 and 11 described previously.

To obtain the ON or OFF states, it is therefore desirable for a potential difference (Vₛ+V_{L}+V_{ON}) applied to a bistable element in the OFF state to switch it to the ON state. See top timing diagram of FIG. 4. A potential difference (Vₛ+V_{ON}) applied to a bistable element in the OFF state not to switch it to the ON state. See bottom timing diagram of FIG. 4.

Let V_{D} be the voltage triggering emission in the electroluminescent layer and V_{Z} be the critical voltage of the photoconductive layer. Below the threshold voltage V_{D} applied between the two layers in series, this cell therefore switches off. Above the voltage V_{D}+V_{Z} applied between the two layers in series, this cell therefore switches on. For a voltage between these layers between V_{D} and V_{D}+V_{Z} the state of the cell does not change.

It is therefore desirable to chose the values of Vₛ, V_{L} and V_{ON} such that
V_{D}<Vₛ<V_{D}+V_{z} and V_{D}<Vₛ+V_{ON}<V_{D}+V_{z}
Vₛ+V_{L}+V_{ON}>V_{D}+V_{Z}

With reference to FIG. 3, there now follows a description of a variant, according to the invention, of the panel described previously.

This variant is distinguished mainly from the panel described previously in that the control means of the bistable elements are separate from the cells and bistable elements in series. In practice, in this case, an addressing electroluminescent cell formed by an electroluminescent layer 5 specific to the terminals of the addressing electrode Aₚ and of the power supply and addressing electrode Yₙ is used as a control means of the bistable element formed by the photoconductive layer 2′ to which it is optically coupled, as illustrated in FIG. 3. For each pixel of the panel, the area of the addressing electroluminescent layer 5 is substantially less than the area of the main electroluminescent layer 4′.

This variant is, however, more complex to produce than the embodiment described previously. In both of the embodiments described above, the area of intersection of the addressing electrodes Aₚ with the electrodes used for power supply addressing Yₙ is far smaller than in the bistable panels with two electrode arrays of the prior art, without this causing any increase in charge loss in the cell power supply circuit since it is independent of the addressing and has far wider electrodes Xₚ, Yₙ.

The capacitive loss for an addressing electrode Aₚ is:
E=C·Va²·N·f·s,
in which C is the capacitance at an intersection of an addressing electrode and a row electrode, N is the number of rows, Va is the addressing voltage, equal to Vₛ+V_{L}+V_{ON}, f is the frame frequency and s is the number of subframes in each frame. Since the area of intersection is smaller than in the bistable panels with two electrode arrays of the prior art, the value of C is far smaller and the capacitive losses are reduced. Moreover, since the panels according to the invention comprise only three electrode arrays, they are simpler and less expensive to produce than the bistable panels with four electrode arrays of the prior art. The invention thus offers improved optimization.

The present invention has been described with reference to an organic electroluminescent panel with photoconductive bistable elements. To a person skilled in the art, it is obvious that it can be applied to other types of bistable electroluminescent panels without departing from the context of the claims below.

1. Bistable electroluminescent panel for displaying images comprising, disposed on a substrate:
an array of electroluminescent cells C_{n,p} and an array of bistable elements B_{n.p}, each associated with a cell and provided with control means,
a first array of electrodes used for power supply Xₚ and a second array of electrodes Yₙ used for power supply,
in which each electroluminescent cell C_{n,p} is linked in series with the bistable element B_{n.p} which is associated with it between an electrode Xₚ of the first power supply array and an electrode Yₙ of the second power supply array,
wherein, to the exclusion of any other array of electrodes linked to the cells, an array of electrodes used mainly for addressing Aₚ, and in that the means of controlling the bistable element of each electroluminescent cell C_{n,p} are linked between an electrode Aₚ of the array used mainly for addressing and a power supply electrode Yₙ of said cell belonging to the second array, which is thus used both for addressing and for power supply.

2. Panel according to claim 1 wherein the electrodes Aₚ of the array used mainly for addressing are narrower than the electrodes Xₚ of the first power supply.

3. Panel according to claim 1 wherein the electrodes Aₚ of the array used mainly for addressing are at least two times narrower than the power supply electrodes Xₚ, Yₙ.

4. Panel according to claim 1 wherein:
the electrodes Yₙ of the second array extend transversally to the electrodes of the first array Xₚ,
the electrodes Aₚ of the array used mainly for addressing extending approximately parallel to the electrodes used only for power supply Xₚ.

5. Panel according to claim 1 wherein each electroluminescent cell C_{n,p} is linked in series with bistabel element B_{n.p} which is associated with it using an electrode forming an intermediate layer.

6. Panel according to claim 5 wherein said intermediate layer is transparent or semi-transparent and in that the bistable element associated with this cell comprises a photoconductive layer which is inserted between said intermediate layer and the power supply electrode Xₚ of the first array.

7. Panel according to claim 6 wherein for each electroluminescent cell C_{n,p}, the means of controlling the associated bistabel element comprise an addressing electroluminescent layer which is inserted between electrode Aₚ used mainly for addressing said cell and the electrode Yₙ used for both addressing and for power supply, and which is optically coupled with the photoconductive layer of said bistable element.

8. Panel according to claim 7 wherein each electroluminescent cell C_{n,p} comprises a main electroluminescent layer which forms one and the same layer with the electroluminescent addressing layer addressing the control means of the bistable element of the cell.

9. Panel according to claim 1 wherein all the power supply electrodes Xₚ of the first array are interlinked at the same potential.

10. Image display device comprising a panel according to claim.
